(19) United States
(12) Patent Application Publication
(10) Pub. No.: US 2004/0102133 A1
(43) Pub. Date: May 27, 2004

(54) Animal-human interactive pet toy

(76) Inventor: Stacy Yarbrough, Plano, TX (US)

Correspondence Address: Steven Thrasher, 391 Sandhill Dr., Richardson, TX, 75080, US

(21) Appl. No.: 10/715,550

(22) Filed: Nov. 16, 2003

Related U.S. Application Data
(63) Continuation-in-part of application No. 10/145,422, filed on May 13, 2002, now abandoned.

(51) Int. Cl. A63H 3/14

(52) U.S. Cl. 446/327

(57) ABSTRACT

The invention provides an animal-human interactive pet toy (the pet toy) comprising an external protective cover formed to resemble the shape of an animal, and an interior shell for comfort and safety. The pet toy promotes interactive play with a pet via realistic appearance such as a moveable mouth, arms, or legs, so as to mimic the play of a real animal.

### RELATED APPLICATION

The present application is a continuation-in-part of and claims priority from co-pending U.S. patent application Ser. No. 10/145,422 to Yarbrough, filed on 13 May 2002.

### TECHNICAL FIELD

Generally, the invention relates to the field of pet accessories, and more particularly, to pet toys for dogs.

### STATEMENT OF A PROBLEM ADDRESSED BY THIS INVENTION

Many pet owners enjoy interacting with their pets, simulating for the pet the play that would take place in the pet's social order in its natural setting and animal species grouping. This play is enjoyable for both pet and human but existing play options have several disadvantages.

Animal-human interaction using existing toys can be dangerous for both the pet and the pet's owner. In the case of the pet owner, this is because when the pet plays in its instinctive manner, the response can be one that is perfectly safe for similar animals, but too violent for some humans.

Another disadvantage is that existing pet toys generally have very limited interaction capability because the human usually can only pull a toy along or tug on a toy against the pull of their pet. There is, therefore, little realistic simulation of animal play or response from the toy. Yet another disadvantage is that existing pet toys are usually inanimate objects, for example, a piece of rope or a ball. These objects do not approach the physical appearance or movement response of natural play found in animal groupings. Thus, pets quickly become bored with the pet toys. Accordingly, to overcome these and other disadvantages associated with existing pet toys it would be advantageous to have a pet toy that address the above listed concerns.

### SELECTED OVERVIEW OF SELECTED EMBODIMENTS

The invention provides technical and operational advantages as an animal-human interactive pet toy. In one embodiment, the animal-human interactive pet toy includes a glove having an interior and an exterior (and also having a sleeve portion), a cover disposed about the exterior of the glove, wherein the cover resembles an animal, and a pad having an exterior that is generally shaped like the animal the cover represents, and having an interior for accepting the glove. The animal-human interactive pet toy may have a glove-insert that has an exterior that fits the interior of the glove, and an interior that fits a human hand.

Preferably, the invention is a toy for a small pet dog, in that it is both visually appealing to a small dog, and in that it provides the user protection from bites and scratches that a dog can make in the ordinary course of play. The invention is absolutely not intended for use as a “bite training” device for police dogs or other “attack” animals.

Of course, other features and embodiments of the invention will be apparent to those of ordinary skill in the art. After reading the specification, and the detailed description of the exemplary embodiment, these persons will recognize that similar results can be achieved in not dissimilar ways. Accordingly, the detailed description is provided as an example of the best mode of the invention and it should be understood that the invention is not limited by the detailed description. Accordingly, the invention should be read as being limited only by the claims.

### BRIEF DESCRIPTION OF THE DRAWINGS

Various aspects of the invention, as well as an embodiment, are better understood by reference to the following EXEMPLARY EMBODIMENT OF A BEST MODE. To better understand the invention, the EXEMPLARY EMBODIMENT OF A BEST MODE should be read in conjunction with the drawings in which:

FIG. 1 is an alternative embodiment of an animal-human interactive pet toy that provides a see-through side view of the invention to illustrate components of the invention;

FIG. 2 is a depiction of one embodiment of an animal-human interactive pet toy that includes a sleeve for a human arm;

FIG. 3 is yet another alternative embodiment of an animal-human interactive pet toy showing a front view;

FIG. 4 is a side view of the embodiment illustrated in FIG. 3; and

FIG. 5 is a rear-view of the embodiment shown in FIG. 3.

### AN EXEMPLARY EMBODIMENT OF A BEST MODE

The invention provides an inventive animal-human interactive pet toy that protects a person's hand and arm, encourages animal-human interaction, and promotes animal exercise and mental stimulation. In one embodiment, the invention is an animal-human interactive pet toy that includes a protective glove for human safety, and a cover that simulates an animal appearance or a non-whimsical “animal” that a pet may find interesting and wish to play with. Because pets love to interact with their owners and with toys, an integration of these two ideas permits greater levels of human interactivity with the pet. Of course, these benefits are among the invention's many advantages that are readily apparent to those of ordinary skill in the art.

When reading this section (An Exemplary Embodiment of a Best Mode, which describes an exemplary embodiment of the best mode of the invention, hereinafter “exemplary embodiment”), one should keep in mind several points. First, the following exemplary embodiment is what the inventor believes to be the best mode for practicing the invention at the time this patent was filed. Thus, since one of ordinary skill in the art may recognize from the following exemplary embodiment that substantially equivalent structures or substantially equivalent acts may be used to achieve the same results in exactly the same way, or to achieve the same results in a not dissimilar way, the following exemplary embodiment should not be interpreted as limiting the invention to one embodiment.

Likewise, individual aspects (sometimes called species) of the invention are provided as examples, and, accordingly, one of ordinary skill in the art may recognize from a following exemplary structure (or a following exemplary act) that a substantially equivalent structure or substantially equivalent act may be used to either achieve the same results in substantially the same way, or to achieve the same results in a not dissimilar way. Accordingly, the discussion of a species (or a specific item) invokes the genus (the class of items) to which that species belongs as well as related species in that genus. Likewise, the recitation of a genus invokes the species known in the art. Furthermore, it is recognized that as technology develops, a number of additional alternatives to achieve an aspect of the invention may arise. Such advances are hereby incorporated within their respective genus, and should be recognized as being functionally equivalent or structurally equivalent to the aspect shown or described.

Second, the only essential aspects of the invention are identified by the claims. Thus, aspects of the invention, including elements, acts, functions, and relationships (shown or described) should not be interpreted as being essential unless they are explicitly described and identified as being essential. Third, a function or an act should be interpreted as incorporating all modes of doing that function or act, unless otherwise explicitly stated (for example, one recognizes that “tacking” may be done by nailing, stapling, gluing, hot gunning, riveting, etc., and so a use of the word tacking invokes stapling, gluing, etc., and all other modes of that word and similar words, such as “attaching”).

Fourth, unless explicitly stated otherwise, conjunctive words (such as “or”, “and”, “including”, or “comprising” for example) should be interpreted in the inclusive, not the exclusive, sense. Fifth, the words “means” and “step” are provided to facilitate the reader's understanding of the invention and do not mean “means” or “step” as defined in 112, paragraph 6 of 35 U.S.C., unless used as “means for functioning—” or “step” for—functioning—“in the Claims section.

### An Exemplary Best Device

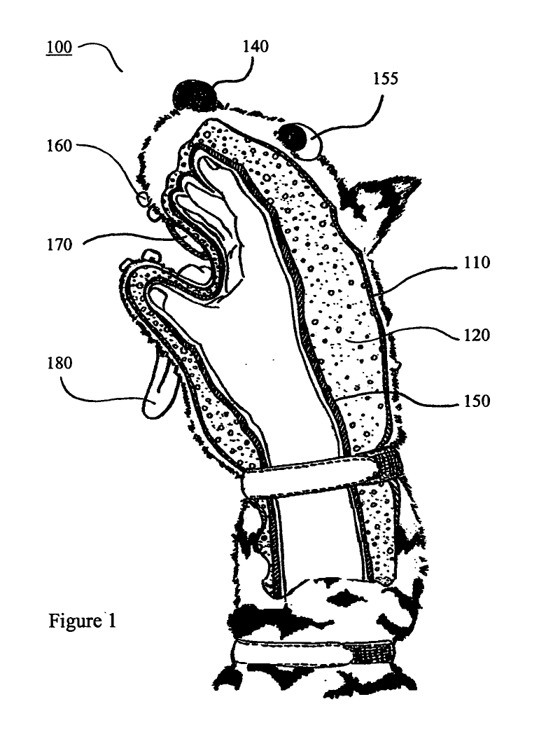

Better understanding of the invention can be gained by referring to figures of exemplary embodiments. Accordingly, FIG. 1 is one embodiment of an animal-human interactive pet toy (the pet toy) 100. FIG. 1 provides a see-through side view of the invention to illustrate components of the invention. The pet toy 100 generally includes a cover 110 that resembles a real or fictional animal, and a protective interior 150 that accommodates a human hand. The cover 110 is preferably a cover that interests a pet animal, such as a dog, cat, bird, or other pet.

Preferably, the invention is a toy for a small pet dog, in that it is both visually appealing to a small dog, and in that it provides the user protection from bites and scratches that a dog can make in the ordinary course of play. The invention is absolutely not intended for use as a “bite training” device for police dogs or other “attack” animals.

In one preferred embodiment, the cover 110 is thick enough and resistant enough to tares to provide protection to a human hand. Additionally, in a preferred embodiment, a safety structural padding (the pad) 120 is disposed between the cover 110 and the protective interior (hereinafter, and preferably a glove) 150 to provide additional bite resistance, increase the “fullness” of the cover (to fill out ears, antlers, and the like), and comfort for a user. Many variations of protective covers will be readily apparent to those of skill in the art, and are thus encompassed within the scope of the claims. The glove 150 conforms to the human hand and to either the inside shape of the pad 120 or the shape of the cover 110. The glove 150 may also have a glove-insert (not shown), which is a glove or hand shaped cover made of a fabric, leather, or other comfortable material. The glove insert provides additional comfort to the wearer/user of the invention, and in some respects also provides additional protection.

Preferably the glove 150 is coupled to the cover 110 via the pad 120 which is has an exterior that is generally shaped like the animal the cover 110 represents, and has an interior that is adapted to receive the glove. Functionally, the pad 120 provides an additional protective layer for a human hand within the glove 150, such as foam, for example. The glove 150, cover 110, and pad are preferably integrally fastened via sewing. The fingertip portion of the glove 150 is sewn inside the portion of cover 110 representing the animal's face such that when at least one finger is articulated the animal's face (cover 110) is animated. Accordingly, it is also preferred to have a portion of the cover 110 into which a person s thumb may be inserted so as to articulate the animal's mouth.

Also disposed on the cover 110 of the pet toy 100 are details that add animal attractiveness and interest to the pet toy 100. These detail elements may be attached by various methods, such as sewing, gluing, epoxying, for example, or may be incorporated into the cover 110 by molding, weaving or other means of attachment. Exemplary details include a nose 140 such as a soft nose, an eye 155, a tooth 160, a tongue 180, a bow, hair, ears, arms, legs, whiskers, or a plurality of any detail. Clothing (not shown), such as hats, coats, shirts, or pants may provide additional details. Preferably, each detail is soft, and it is also preferable for each detail to be bite-resistant (as far as possible). Of course, other details may be provided, and are limited only by the creativity of the designer of the pet toy 100, and are thus envisioned within the scope of the claims.

Features may also comprise part of the invention. For example, the pet toy 100 may include a noisemaker 170 such as a squeaker, or clicker, for example. Additional features, such as glowing eyes or details, or a flavored cover 110 are also available. Further advantages can be realized by securing the pet toy 100 to a person's hand. Accordingly, attachment means, such as straps which could be Velcro™™, or belts, for example, may be provided about a forearm portion of the cover 110 so that a user can secure the pet toy 100 about their forearm, wrist, or elbow. Of course, other means of securing the pet toy 100 to an arm are available, and readily apparent to those of ordinary skill in the art, and these variations are within the scope of the invention's claims.

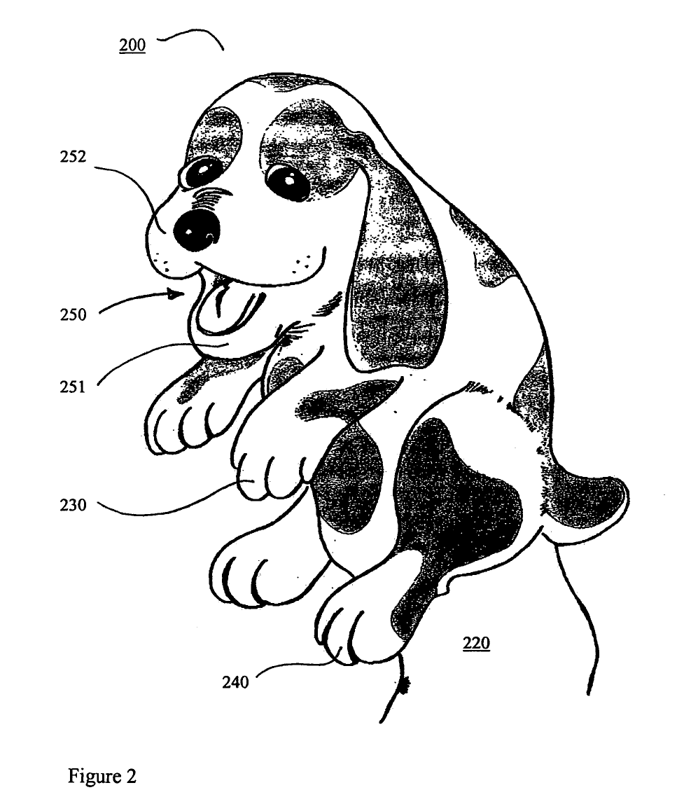

FIG. 2 is a depiction of one embodiment of an animal-human interactive pet toy (the pet toy) 200 that includes a sleeve 220 for a human arm. Like the pet toy 100, the pet toy 200 provides details such as a movable mouth 250 having an upper jaw 252 and a lower jaw 251, front legs 230 and rear legs 240. In a preferred embodiment, the details are resiliently coupled to the pet toy 200. In addition, the pet toy 200 is illustrated as being a puppy hound.

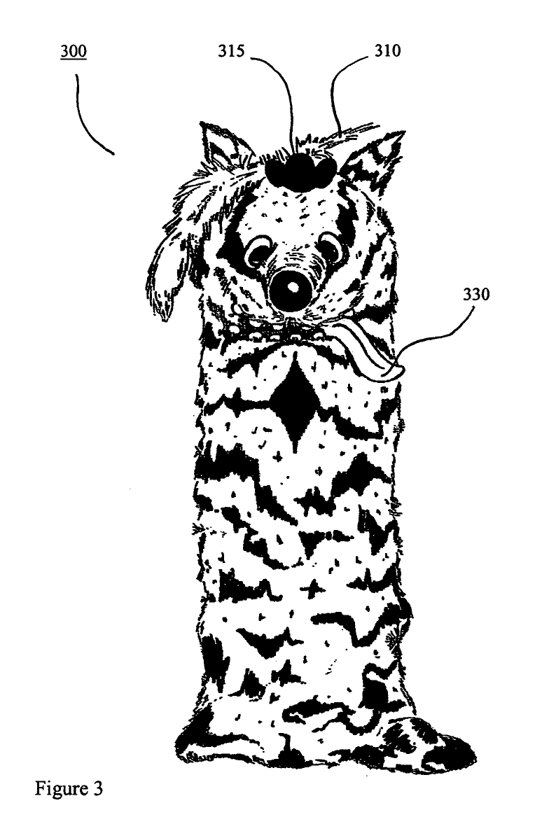

FIG. 3 is yet another alternative embodiment of an animal-human interactive pet toy 300 showing a front view. FIG. 3 depicts one alternative embodiment for a fictional pet toy. Note that the pet toy 300 incorporates clothing details, such as a feather 310, a bow 315, and a side-disposed tongue 330. Other details are shown, such as ears, eyes, a nose, and teeth.

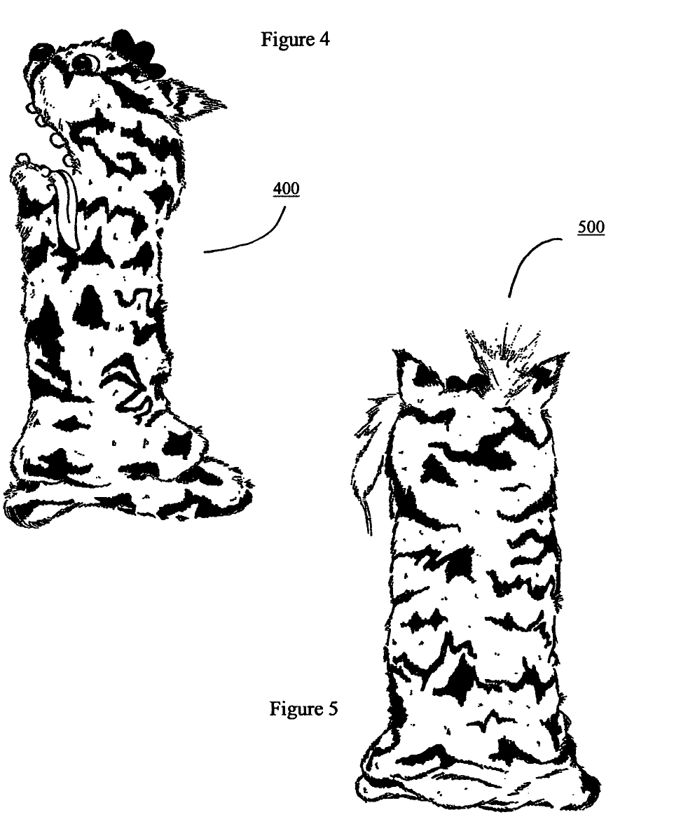

FIG. 4 is a side view of the embodiment illustrated in FIG. 3. Of interest in FIG. 3 is the side-view of the side-disposed tongue 330, which animals find particularly intriguing. Note also that the pet toy is designed to be completely integrated with the middle pad and glove, such that the pet toy 300 completely covers the sleeve of the middle pad and glove. Similarly, FIG. 5 is a rear-view of the embodiment shown in FIG. 3.

Though the invention has been described with respect to a specific preferred embodiment, many variations and modifications will become apparent to those skilled in the art upon reading the present application. For example, although the specific embodiment of an animal-human interactive pet toy has been described, it should be understood that the principles taught herein can be applied to other pet toys or stuffed animals when modifications and adjustments are made. Thus, one alternative embodiment of the invention may incorporate arms and legs that can be moved directly by fingers, or by strings as in puppetry. It is therefore the intention that the appended claims be interpreted as broadly as possible in view of the prior art to include all such variations and modifications.

I claim:

1. An animal-human interactive pet dog toy, comprising:
a glove having an interior and an exterior, and also having a sleeve portion;
a pad having an exterior that is generally shaped like an animal, and an interior that is adapted to accept the glove, the pad accordingly disposed about the glove; and
a cover disposed about the exterior of the pad, wherein the cover resembles a character.

2. The pet toy of claim 1, wherein the cover is customized to resemble the appearance of a unique, specific pet selected by a user.

3. The pet toy of claim 1, wherein the cover resembles an animal.

4. The pet toy of claim 1, wherein the cover has a sleeve portion coupled about the sleeve portion of the exterior glove, such that the sleeve portion of the cover and the sleeve portion of the glove cover a user's forearm.

5. The pet toy of claim 4, wherein the sleeve portion of the cover is integrally molded with the sleeve portion of the glove.

6. The pet toy of claim 1, wherein the cover resembles an animal.

7. The pet toy of claim 1, wherein the cover resembles a fictional character.

8. The pet toy of claim 4, wherein the mouth has at least one soft, chew-resistant tooth.

9. The pet toy of claim 1, wherein the cover comprises a shaggy surface.

10. The pet toy of claim 1, wherein the cover slips over the pad.

11. The pet toy of claim 1, wherein the cover comprises a tongue.

12. The pet toy of claim 1, wherein the cover is one of a plurality of interchangeable covers.

13. The pet toy of claim 9, wherein the cover is resiliently coupled to the pad.

14. The pet toy of claim 9, wherein the facial characteristic is resiliently coupled to the cover.

15. The pet toy of claim 1, wherein the cover comprises a noise-generating device.

16. The pet toy of claim 1, further comprising a glove-insert disposed within the interior of the glove.

17. The pet toy of claim 9, wherein the glove is plastic.

18. The pet toy of claim 9, wherein the glove is a thick fabric.

19. The pet toy of claim 9, wherein the glove is wool.

20. The pet toy of claim 9, wherein the glove-insert has an exterior that fits the interior of the glove, and the glove-insert also has an interior that fits a human hand.
